(19) United States
(12) Patent Application Publication
(10) Pub. No.: US 2026/0111607 A1
(43) Pub. Date: Apr. 23, 2026

(54) SYSTEMS AND METHODS FOR PROTECTING PROFILES IN A PROTECTED DATASET MAINTAINED IN A SECURED NETWORK LOCATION

(71) Applicant: AML JV, LLC, Aurora, CO (US)

(72) Inventors: Justin DALE, Aurora, CO (US); Frank MARKSON, Aurora, CO (US); Brett STEVENS, Aurora, CO (US); Austin GILLEN, Aurora, CO (US); Md Nazmul ISLAM, Aurora, CO (US)

(73) Assignee: AML JV, LLC, Aurora, CO (US)

(21) Appl. No.: 19/364,541

(22) Filed: Oct. 21, 2025

Related U.S. Application Data
(60) Provisional application No. 63/710,560, filed on Oct. 22, 2024.

(51) Int. Cl. G06F 21/62

(52) U.S. Cl. CPC G06F 21/6254

(57) ABSTRACT

Disclosed are systems for de-identifying individual data to reduce the chances of re-identification of individuals when training machine learning models. A system can include one or more processors that are configured to obtain individual data for an individual; obtain sample data generated based on an output of a processing system at a second point in time when processing a sample obtained from the individual; and generate a treatment profile based on the individual data and the sample data. The one or more processors can be configured to de-identify the treatment profile of the individual to generate a limited treatment profile. In examples, the one or more processors can then be configured to provide the limited profile data associated with the limited treatment profile to a device to allow the device to execute one or more operations involved in training or implementing a neural network.

### CROSS-REFERENCE TO RELATED APPLICATION

The present disclosure claims the benefit of, and priority to, U.S. Provisional Patent Application No. 63/710,560 , filed Oct. 22, 2024, the entire contents of which are hereby incorporated by reference in their entirety.

### TECHNICAL FIELD

This application relates generally to systems and methods for protecting profiles in a protected dataset maintained in a secured network location and, in some implementations, to techniques for de-identifying patient data for training machine learning models to reduce the chances of re-identification of individuals (e.g., patients) when implementing the machine learning models.

### BACKGROUND

While healthcare providers have traditionally relied on established clinical guidelines and expert knowledge to make diagnostic and treatment decisions, recent development of machine learning-based techniques to process large datasets of patient data have shown promise in improving patient treatment and outcomes. For example, machine learning models can be trained to identify patterns across large cohorts of patients to produce more accurate disease diagnoses. But personal health information (PHI) can unintentionally be disseminated through model leakage by virtue of these models learning specific patterns or details from the patient data during training. Conventional techniques aimed at preventing re-identification of anonymized versions of patient data can fail as models improve and infer or reconstruct the supposedly anonymized information through correlations and patterns within the data. Additionally, these conventional techniques can modify important patterns in the datasets, resulting in training datasets that can train models to give incorrect answers.

### SUMMARY

For the aforementioned reasons, there is a need for systems and methods that can de-identify individual data by updating information that can link an individual to their treatment profile to reduce the chances of such individual re-identification. The techniques implemented by the systems and methods disclosed herein allow clinicians (e.g., doctors and/or oncologists, nurses, pathologists, and/or the like) to input individual data that is de-identified before training and/or updating machine learning models. For example, a clinician can input information about an individual (e.g., biographic information, test results, and/or the like) to create a treatment profile for the individual. This treatment profile can contain biographical information and/or information derived from the processing of individual samples (e.g., a DNA sequence determined based on the individual sample and/or the like). Systems can then de-identify the treatment profile before using it to train or implement a machine learning model. This de-identified data can be used to train machine learning models as described such that there is a reduced or eliminated chance of individual re-identification based on the outputs of the model. The de-identified data can also maintain one or more aspects such as temporal relationships between events tracked during the treatment of the individuals and/or the like.

In an embodiment, disclosed is a system that can include one or more processors. The one or more processors can be configured to obtain individual data for an individual. The individual data can be associated with an individual profile and generated at a first point in time. In some implementations, the one or more processors can be configured to obtain sample data associated with one or more indicators (e.g., biomarkers, etc.) for a condition. The sample data can be generated based on an output of a processing system at a second point in time when processing a sample obtained from the individual. The one or more processors can be configured to generate a treatment profile based on the individual data and the sample data. The treatment profile can include a plurality of entries indexed in accordance with a period of time. The plurality of entries can represent the individual profile and/or the one or more indicators for the condition. The treatment profile of the individual can be de-identified to generate a limited treatment profile. The limited profile data associated with the limited treatment profile can be provided to a device. The device to execute one or more operations involved in training or implementing a neural network based in response to receiving the limited profile data.

In some aspects, the one or more processors configured to generate the treatment profile can be further configured to generate a profile identifier. The profile identifier can be based on one or more aspects of the profile of the individual. The one or more processors configured to de-identify the treatment profile of the individual can be configured to generate a pseudo-identifier and/or map the pseudo-identifier to the profile identifier in a de-identified data index. The processors can also be configured to generate the limited treatment profile based on the pseudo-identifier, wherein the pseudo-identifier is used as a replacement for the profile identifier.

In aspects, the one or more processors configured to generate the pseudo-identifier can be further configured to determine one or more aspects of the treatment profile to be used when generating the pseudo-identifier. The processors can also be configured to apply a cryptographic hash function to the one or more aspects of the treatment profile to generate the pseudo-identifier.

In at least some aspects, the one or more processors configured to de-identify the treatment profile of the individual can be further configured to determine a first period of time associated with the treatment profile of the individual. The first period of time can start at the first point in time corresponding to a first entry in the treatment profile. The one or more processors can determine a period offset that maintains one or more aspects of the treatment profile. The one or more processors configured to generate the limited treatment profile can be configured to determine an updated set of entries based on the plurality of entries of the treatment profile and the period offset. The updated set of entries can be determined such that time stamps of the plurality of entries of the treatment profile are shifted in accordance with the period offset.

In some aspects, the one or more processors can be further configured to determine a transition of the treatment profile from a first state to a second state. The transition can indicate an update to the plurality of entries of the treatment profile. The one or more processors can update the limited treatment profile based on the update to the plurality of entries of the treatment profile.

In aspects, the one or more processors can be further configured to identify a subset of entries of the plurality of entries that are added to the treatment profile. The one or more processors configured to update the limited treatment profile can be further configured to de-identify a portion of the treatment profile corresponding to the subset of entries and update the limited treatment profile based on the portion of the treatment profile that was de-identified.

In at least some aspects, the one or more processors configured to provide the limited profile data associated with the limited treatment profile to the device can be further configured to provide the limited treatment profile to a model development environment executed by the device. In response to receiving the limited treatment profiles, the model development environment can generate an update to the plurality of entries of the limited treatment profile. The model development environment can include a plurality of neural networks. The plurality of neural networks can be configured to receive the limited treatment profile (e.g., the entries of the limited treatment profile) as an input and generate the update to the plurality of entries of the limited treatment profile as an output. The one or more processors can be configured to determine one or more updates to the plurality of entries of the treatment profile based on the update to the plurality of entries of the limited treatment profile; and update the treatment profile based on the one or more updates to the plurality of entries.

In some aspects, the plurality of entries of the limited treatment profile are associated with a pseudo-identifier of the individual. The one or more processors configured to determine the one or more updates to the plurality of entries of the treatment profile can be configured to determine the profile identifier for the individual based on the pseudo-identifier associated with the plurality of entries of the limited treatment profile, a period offset mapped to the profile identifier for the individual, and a set of entries to include in the treatment profile based on the plurality of entries of the limited treatment profile. Each entry including a time stamp that is not shifted in accordance with a period offset associated with the limited treatment profile.

Another embodiment relates to a method. The method can include obtaining individual data for an individual. The individual data can be associated with an individual profile and generated at a first point in time. In some embodiments, the method includes obtaining sample data associated with one or more indicators for a condition. The sample data can be generated based on an output of a processing system at a second point in time when processing a sample obtained from the individual. In some embodiments, the method includes generating a treatment profile based on the individual data and the sample data. The treatment profile can include a plurality of entries indexed in accordance with a period of time. The plurality of entries can represent the individual profile and/or the one or more indicators for the condition. In some embodiments, the method includes de-identifying the treatment profile of the individual to generate a limited treatment profile. In some embodiments, the method includes providing the limited profile data associated with the limited treatment profile to a device to allow the device to execute one or more operations involved in training or implementing a neural network.

In some aspects, the method further includes generating a profile identifier based on one or more aspects of the profile of the individual. In some embodiments, de-identifying the treatment profile of the individual further includes generating a pseudo-identifier. The pseudo-identifier can be mapped to the profile identifier in a de-identified data index. In some embodiments, de-identifying the treatment profile further includes generating the limited treatment profile based on the pseudo-identifier. The pseudo-identifier can be used as a replacement for the profile identifier.

In at least some aspects, generating the pseudo-identifier further includes determining one or more aspects of the treatment profile to be used when generating the pseudo-identifier. A cryptographic hash function can be applied the one or more aspects of the treatment profile to generate the pseudo-identifier.

In aspects, de-identifying the treatment profile of the individual further includes determining a first period of time associated with the treatment profile of the individual. The first period of time can start at the first point in time corresponding to a first entry in the treatment profile. De-identifying the treatment profile can further include determining a period offset that maintains one or more aspects of the treatment profile. In some embodiments, generating the limited treatment profile further includes determining an updated set of entries based on the plurality of entries of the treatment profile and the period offset such that time stamps of the plurality of entries of the treatment profile are shifted in accordance with the period offset.

In some aspects, the method further includes determining a transition of the treatment profile from a first state to a second state. The transition can indicate an update to the plurality of entries of the treatment profile. The method can further include updating the limited treatment profile based on the update to the plurality of entries of the treatment profile.

In at least some aspects, the method further includes identifying a subset of entries of the plurality of entries that are added to the treatment profile. In some embodiments, updating the limited treatment profile further includes de-identifying a portion of the treatment profile corresponding to the subset of entries and updating the limited treatment profile based on the portion of the treatment profile that was de-identified.

In aspects, providing the limited profile data associated with the limited treatment profile further includes providing the limited treatment profile to a model development environment executed by the device. This can cause the model development environment to generate an update to the plurality of entries of the limited treatment profile. The model development environment can include a plurality of neural networks that can be configured to receive the limited treatment profile as an input and generate the update to the plurality of entries of the limited treatment profile as an output. In some embodiments, providing the limited profile data associated with the limited treatment profile further comprises determining one or more updates to the plurality of entries of the treatment profile based on the update to the plurality of entries of the limited treatment profile and updating the treatment profile based on the one or more updates to the plurality of entries.

Yet another embodiment relates to a non-transitory computer-readable medium storing instructions thereon that, when executed by at least one processor, can cause the at least one processor to obtain individual data for an individual. The individual data can be associated with an individual profile and generated at a first point in time. In some embodiments, the non-transitory computer-readable medium causes the at least one processor to obtain sample data associated with one or more indicators for a condition. The sample data can be generated based on an output of a processing system at a second point in time when processing a sample obtained from the individual. In some embodiments, the non-transitory computer-readable medium causes the at least one processor to generate a treatment profile based on the individual data and the sample data. The treatment profile can include a plurality of entries indexed in accordance with a period of time. The plurality of entries can represent the individual profile and/or the one or more indicators for the condition. In some embodiments, the non-transitory computer-readable medium causes the at least one processor to de-identify the treatment profile of the individual to generate a limited treatment profile and provide the limited profile data associated with the limited treatment profile to a device. In response to receiving the limited profile data, the device can execute one or more operations involved in training or implementing a neural network.

In some aspects, the instructions further causes the at least one processor to determine a transition of the treatment profile from a first state to a second state. The transition can indicate an update to the plurality of entries of the treatment profile. In some embodiments, the instructions cause the at least one processor to update the limited treatment profile based on the update to the plurality of entries of the treatment profile.

In aspects, the instructions further cause the at least one processor to identify a subset of entries of the plurality of entries that are added to the treatment profile. The one or more processors configured to update the limited treatment profile can be further configured to de-identify a portion of the treatment profile corresponding to the subset of entries and update the limited treatment profile based on the portion of the treatment profile that was de-identified.

In at least some aspects, the instructions cause the at least one processor configured to provide the limited profile data associated with the limited treatment profile to the device further cause the at least one processor to provide the limited treatment profile to a model development environment executed by the device. This can cause the model development environment to generate an update to the plurality of entries of the limited treatment profile. The model development environment can include a plurality of neural networks. The plurality of neural networks can be configured to receive the limited treatment profile as an input and generate the update to the plurality of entries of the limited treatment profile as an output. One or more updates to the plurality of entries of the treatment profile based on the update to the plurality of entries of the limited treatment profile can be determined. In some embodiments, the instructions cause the at least one processor configured to provide the limited profile data cause the at least one processor to update the treatment profile based on the one or more updates to the plurality of entries.

In aspects, the plurality of entries of the limited treatment profile can be associated with a pseudo-identifier of the individual. The instructions that cause the at least one processor to determine the one or more updates to the plurality of entries of the treatment profile can cause the at least one processor to determine the profile identifier for the individual based on the pseudo-identifier associated with the plurality of entries of the limited treatment profile, determine a period offset mapped to the profile identifier for the individual, and determine a set of entries to include in the treatment profile based on the plurality of entries of the limited treatment profile. Each entry can include a time stamp that is not shifted in accordance with a period offset associated with the limited treatment profile.

By virtue of the implementation of the techniques described herein, individual data can be used to train, update, and/or implement machine learning models that reduce the chances of unintentional dissemination of patient health information (PHI). For example, clinicians can use the systems and methods to input individual data. The system can then create treatment profiles with data representing the PHI of a patient, updating and/or removing data that could potentially identify individuals when generating limited treatment profiles. Based on training a machine learning model on the limited treatment profiles, the system can train models with the ability to make predictions about diagnoses and/or recommendations for treatment methods based on these limited treatment profiles.

During implementation, the system can input data associated with the limited treatment profiles to machine learning models to cause the models to execute and output predictions that are based on the entries in the limited treatment profiles. In examples, the system can then re-identify the treatment profile associated with the output of the model and update the treatment profile based on the predictions. While conventional techniques can result in data leakage as a result of how they were trained, the models described herein may only interact with (e.g., are trained using) the limited treatment profiles. And by virtue of how the treatment profiles are de-identified to generate the limited treatment profiles, the chances of re-identification when implementing the trained and/or updated models described herein (and, by extension, disclosing PHI) are reduced or eliminated. As a result, the models described herein can be provided to other (e.g., third-party) devices to be executed, allowing other clinicians not involved in the generation of the models to use the models when diagnosing and/or treating patients without the risk of disseminating PHI. This, in turn, can allow these other clinicians to implement improved diagnoses and treatment decisions. Further, because one or more aspects of the treatment profiles are maintained (e.g., temporal relationships between events tracked during the treatment of the patients and/or the like), the model can be trained to generate predictions with improved accuracy as opposed to conventional models which may be trained on redacted and, therefore, incomplete treatment profiles. This further improves the accuracy of the trained and/or updated models described herein when compared to conventionally-trained models.

### BRIEF DESCRIPTION OF THE DRAWINGS

The accompanying drawings constitute a part of this specification, illustrate one or more embodiments and, together with the specification, explain the subject matter of the disclosure.

FIG. 1 is a block diagram of an environment in which one or more devices operate to process patient data, in accordance with one or more embodiments described herein.

FIG. 2 is a flow diagram illustrating operations of a method for managing patient data, in accordance with one or more embodiments described herein.

FIG. 3A-3G are a diagram of an example implementation of the method of FIG. 2, in accordance with one or more embodiments described herein.

### DETAILED DESCRIPTION

Reference will now be made to the embodiments illustrated in the drawings, and specific language will be used here to describe the same. It will nevertheless be understood that no limitation of the scope of the disclosure is thereby intended. Alterations and further modifications of the features illustrated here, and additional applications of the principles as illustrated here, which would occur to a person skilled in the relevant art and having possession of this disclosure, are to be considered within the scope of the disclosure.

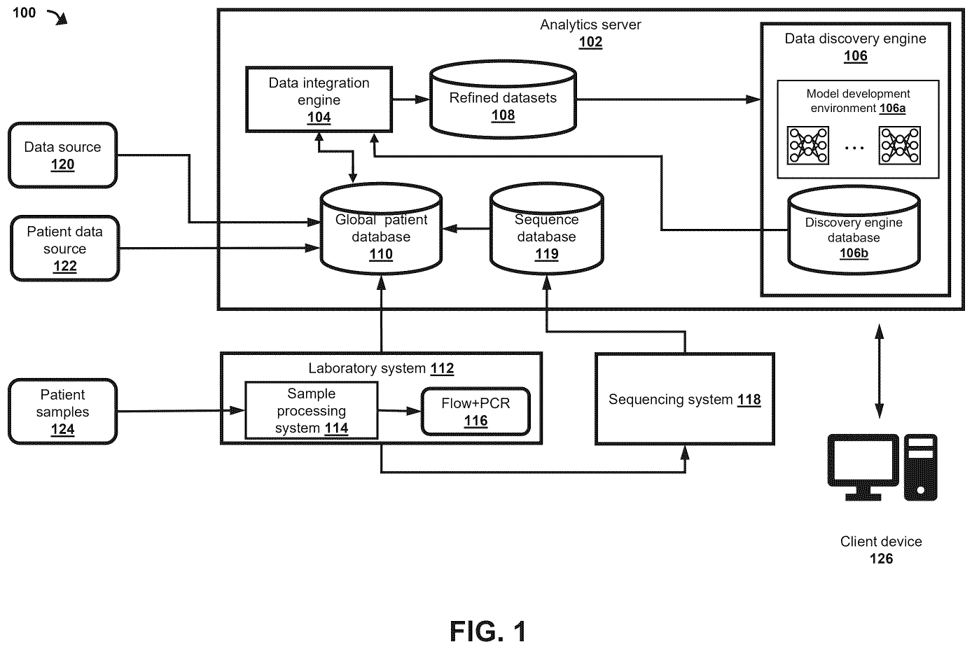

FIG. 1 is a block diagram of an environment 100 for managing patient data, according to an embodiment. The environment 100 can include an analytics server 102, a laboratory system 112, a sequencing system 118, a data source 120, patient data source 122, patient samples 124, and a client device 126. Various components depicted in FIG. 1 can belong to an organization involved in clinical research of one or more conditions including diseases such as, for example, acute myeloid leukemia (AML) or other diseases and/or to one or more organizations involved in treating patients with the one or more diseases. While certain components and devices are illustrated as being included in the environment 100 of FIG. 1, it will be understood that the environment 100 is not confined to the components or diseases as described herein and can include additional or different components (not shown for purposes of brevity and clarity) which are configured to be considered within the scope of the embodiments described herein.

In some embodiments, the analytics server 102 can include any computing device comprising a processor and non-transitory machine-readable storage capable of executing the various tasks, processes, and/or operations as described herein. The analytics server 102 can employ various processors such as central processing units (CPUs), graphical processing units (GPUs), and/or the like. Some non-limiting examples of such computing devices can include workstation computers, laptop computers, server computers, and/or the like. While the environment 100 includes a single analytics server 102, there can be multiple analytics servers 102. Further, the analytics server 102 can include any number of computing devices operating in a distributed computing environment such as, for example, a cloud computing environment. As described herein, the analytics server 102 can include a data integration engine 104, a data discovery engine 106, refined datasets 108, a global patient database 110, and a sequence database 119. In some embodiments, the analytics server 102 can include and/or implement operations that are associated with the laboratory system 112, the sequencing system 118, and/or the client device 126. In some embodiments, the analytics server 102 can include and/or implement operations that are associated with (e.g., involved in the generation of) the data source 120, the patient data source 122, and/or the patient samples 124.

In some embodiments, the analytics server 102 can be configured to receive data from the data source 120, the patient data source 122, and the laboratory system 112 and sequencing system 118 when processing patient samples 124. For example, the analytics server 102 can be configured to receive data from the data source 120, where the data is associated with (e.g., represents) entries corresponding to one or more patient files. As an example, as patients interact with clinicians, the clinicians can generate information that are received as input at a client device (not explicitly illustrated) that is associated with the clinicians, the notes indicating clinical observations and/or updates to treatment plans for the patients made by the clinician. The client device can then generate patient data that is associated with each patient and representative of the clinical observations or updates to the treatment plans and store the patient data in the data source 120 to later transmit to the analytics server 102. In this example, the analytics server 102 can implement the global patient database 110 such that the patient data is uploaded and stored in the global patient database 110 in association with one or more identifiers for the patient as described herein.

In another example, the analytics server 102 can be configured to receive data from the patient data source 122, where the data is associated with (e.g., represents) information about individual patients. As an example, as a history of a patient is obtained, the clinicians and/or the patients can generate information that is received as input at a client device (not explicitly illustrated) that is associated with the clinicians and/or patients, the information indicating aspects of the history of the patient such as whether the patient is associated with a history of a given disease in their family, whether the patient had any exposure to environmental conditions associated with the given disease, and/or the like. The client device can then generate patient data that is associated with each patient and representative of the history of the patient and store the patient data in the patient data source 122 to later transmit to the analytics server 102. In this example, the analytics server 102 can obtain and store the patient data in the global patient database 110 in association with one or more identifiers for the patient as described herein.

In yet another example, the analytics server 102 can be configured to receive data from the laboratory system 112 and/or the sequencing system 118, where the data is associated with (e.g., represents) information about patient samples (e.g., tissue samples, blood samples, blood counts (e.g., complete blood counts), bone marrow aspiration and biopsy results, lumbar puncture results, and/or the like) as well as the results of the processing of the samples (e.g., a DNA sequence or targets thereof). As an example, as a patient is evaluated and/or treated for a disease such as AML, patient samples 124 similar to those described above can be obtained. The patient samples 124 can be initially obtained and processed by a laboratory system 112 and processed by a sample processing system 114. The sample processing system 114 can implement one or more devices configured to obtain and store the patient samples and extract DNA from the patient samples. For example, in preparation for genetic analysis to guide AML treatment, patient blood or bone marrow can first be obtained from a patient and then frozen. Later, these samples can be quality checked to ensure the sample purity and quantity are sufficient for sequencing. In some embodiments, the isolated DNA can then undergo further processing to be separated into manageable fragments and equipped with adapters (e.g., short, specific pieces of synthetic DNA associated with the fragmented DNA molecules) for compatibility with sequencing machines. In some embodiments, the samples can also be provided to a flow and polymerase chain reaction (PCR) system to extract and amplify the isolated DNA. The laboratory system 112 can then provide the processed samples and corresponding data representing the samples to be processed by the sequencing system 118. Additionally, or alternatively, the laboratory system 112 can then provide the data generated by the laboratory system 112 when processing the samples to the analytics server 102 to be stored in the global patient database 110.

In some embodiments, the sequencing system 118 can be configured to receive the patient samples and/or the isolated DNA and sequence the patient samples. In one example, the sequencing system 118 can attach DNA fragments to a surface in a specific pattern, creating clusters. The sequencing itself can involve a series of cycles where fluorescently labeled nucleotides are introduced one by one. The incorporation of each base can be detected, identifying the sequence of the fragment base by base. Finally, the sequencing system 118 can analyze the vast amount of data, assemble the original DNA sequences and identify any variations or mutations present (sometimes referred to as Next-Generation Sequencing (NGS)). The sequencing system 118 can then provide data associated with the sequenced DNA to the analytics server 102. In this example, the analytics server 102 can store the sequenced DNA in a sequence database 119 that stores the sequenced DNA in association with one or more profile identifiers established by the analytics server 102. In some embodiments, the analytics server 102 can also cause the sequence database 119 to provide the data associated with the sequenced DNA to the global patient database 110 to be stored in association with other data associated with the patient such as a treatment profile and/or limited treatment profile for the patient as described herein.

In some embodiments, the analytics server 102 can implement a data integration engine 104 to process data stored in the global patient database 110. For example, the analytics server 102 can implement the data integration engine 104 such that the data integration engine 104 is configured to obtain the data associated with the patients that is stored in the global patient database 110 and processes the data to be used by the data discovery engine 106. In one example, as data is obtained by the global patient database 110 for a given patient, the data can be stored in the global patient database 110 in association with one or more identifiers as part of a profile for the patient. The data integration engine 104 can then obtain the data associated with the patient (e.g., the entire profile or portions thereof) from the global patient database 110 and process the data to generate a limited treatment profile. The limited treatment profile can then be stored in the refined datasets database 108 (referred to herein as “refined datasets”) and made available to the data discovery engine 106. In this way, the analytics server 102 can maintain two separate datasets that allow for updates to the limited treatment profiles stored in the refined datasets 108 and subsequent use by the data discovery engine 106 when performing the operations described herein. As will be understood, in this example, the data associated with the patient that is stored in the global patient database 110 can be updated over time such that the patient profile is represented as a set of entries associated with a time series. As the global patient database 110 is updated, the data integration engine 104 can obtain updated versions of the data associated with the patient from the global patient database 110, process the data when updating the limited treatment profiles in the refined datasets 108, and store the updates in the refined datasets 108.

In some embodiments, the analytics server 102 can implement the data discovery engine 106 that includes a model development environment 106a and a discovery engine database 106b. For example, the analytics server 102 can implement the data discovery engine 106 such that the data discovery engine 106 is configured to receive data associated with one or more limited treatment profiles that are stored in the refined datasets 108 and process the one or more limited treatment profiles. In this example, the analytics server 102 can process the one or more limited treatment profiles using the model development environment 106a. Processing the limited treatment profiles can include providing the limited treatment profiles to one or more models (e.g., machine learning-based models, including supervised models such as linear regression models and unsupervised models such as clustering models, and/or the like) to determine one or more metrics. The one or more metrics can represent the performance of each of the models, indicating which model or groups of models are more or less accurate, efficient, and/or the like at generating one or more predictions compared to one or more other models. These predictions can include indications of treatment options that have a likelihood of optimizing an outcome (e.g., life extension) for the patients. In some embodiments, the analytics server 102 can process the limited treatment profiles to determining one or more aspects of the limited treatment profiles. For example, where the limited treatment profile is associated with a predetermined number of possible attributes but the patient samples 124 that are available are limited and only usable to determine a subset of the possible attributes, the model development environment 106a can process the portions of the refined patient profile that are available in the refined datasets 108 to determine one or more of the remaining attributes of the possible attributes. In this example, data associated with the one or more remaining attributes can be stored by the data discovery engine 106 in the discovery engine database 106b along with an identifier from the limited treatment profile (e.g. the pseudo-identifier and/or other entries in the limited treatment file). The analytics server 102 can then periodically or in real-time update the global patient database 110 based on the data associated with the limited treatment profiles (e.g., the one or more remaining attributes and/or the like) that are stored in the discovery engine database 106b.

In some embodiments, the data associated with the one or more remaining attributes can be transmitted by the discovery engine database 106b to the data integration engine 104. The data integration engine 104 can identify to which treatment profile and/or limited treatment profile the data associated with the one or more remaining attributes corresponds, based on the identifier. In some embodiments, the data integration engine 104 can then update the treatment profile and/or the limited treatment profile in accordance with the one or more remaining attributes. For example, the data integration engine 104 can update the treatment profile and/or the limited treatment profile with an indication of the appropriate treatment (e.g., that is predicted to optimize the lifespan of the patient) based on analysis of the entries of the treatment profile and/or limited treatment profile. In an example, the data integration engine can access the global patient database 110 and update the entries of the treatment profile in accordance with the remaining attributes. In another example, the data integration engine 104 can access the refined datasets 108 and update the entries of the limited treatment profile in accordance with the remaining attributes.

In some embodiments, the client device 126 can include any computing device comprising a processor and non-transitory machine-readable storage capable of executing the various tasks, processes, and/or operations as described herein. The client device 126 can employ various processors such as central processing units (CPUs), graphical processing units (GPUs), and/or the like. Some non-limiting examples of such computing devices can include workstation computers, laptop computers, server computers, and/or the like. While the environment 100 includes a single client device 126, there can be multiple client devices 126. Further, the client device 126 can include any number of computing devices operating in a distributed computing environment such as, for example, a cloud computing environment. In some embodiments, the client device 126 can be associated with one or more software developers and/or one or more clinicians that are interacting with (e.g., configuring operation of) the analytics server 102 as described herein. In some embodiments, the client device 126 can be associated with one or more clinicians and/or one or more organizations involved in treating patients with the one or more diseases such as a hospital and/or the like.

In some embodiments, the analytics server 102 can generate and display an electronic platform (e.g., via the client device 126) when receiving and processing patient data associated with one or more patients, performing one or more operations when analyzing the patient data, and outputting data associated with the results of the operations performed by any of the components of the analytics server 102 such as, for example, the data discovery engine 106. The electronic platform can include graphical user interfaces (GUI) displayed by display devices of one or more client devices 126. An example of the electronic platform generated and hosted by the analytics server 102 can be a web-based application or a website configured to be displayed on different electronic devices, such as mobile devices, tablets, personal computers, and the like.

In some embodiments, treatment profiles and/or limited treatment profiles may be analyzed to identify trends, commonalities, and divergences across patients or patient subgroups. Such analysis can include direct comparison of temporal treatment sequences, cumulative dosing exposures, treatment intensities, or intervals between successive interventions. By evaluating these patterns, clinicians and researchers may discern which specific treatment pathways or regimen characteristics are consistently associated with improved or diminished outcomes, the analytics server 102 can execute one or more operations to assist with clinical decision-making. In certain cases, composite measures derived from the treatment profiles (e.g., such as dose-density indices, treatment adherence scores, or timing-of-intervention metrics) can be calculated and examined to assess their relationship to patient outcomes. The analysis may additionally include the use of statistical or machine learning algorithms to identify correlations between specific intervention sequences, dosing regimens, or therapeutic combinations and one or more clinical outcome metrics. Such analysis may involve aggregating patient-level treatment history data, mapping these histories against measured outcomes such as overall survival, event-free survival, progression-free survival, or response rates, and applying predictive modeling to determine which profile features are most strongly associated with favorable clinical endpoints. The resulting output generated by the analytics server 102, represented by the treatment profiles, can be used to generate user interfaces that can be displayed (e.g., at the client device 126) to indicate therapies to administer and/or allow for personalized treatment recommendations, optimize protocol design, or adjust ongoing therapy, thereby improving patient prognosis and enhancing resource utilization in clinical practice.

The above-mentioned components can be configured to interconnect with to each other and establish communication connections therebetween through a network (not explicitly illustrated). Examples of the network can include, but are not limited to, private or public local-area-networks (LAN), wireless LAN (WLAN) networks, metropolitan area networks (MAN), wide-area networks (WAN), and the Internet. The network can include wired and/or wireless communications according to one or more standards and/or via one or more transport mediums. The communication over the network can be performed in accordance with various communication protocols such as Transmission Control Protocol and Internet Protocol (TCP/IP), User Datagram Protocol (UDP), and IEEE communication protocols. In one example, the network can include wireless communications according to Bluetooth specification sets or another standard or proprietary wireless communication protocol. In another example, the network can also include communications over a cellular network, including, e.g., a GSM (Global System for Mobile Communications), CDMA (Code Division Multiple Access), and EDGE (Enhanced Data for Global Evolution) network.

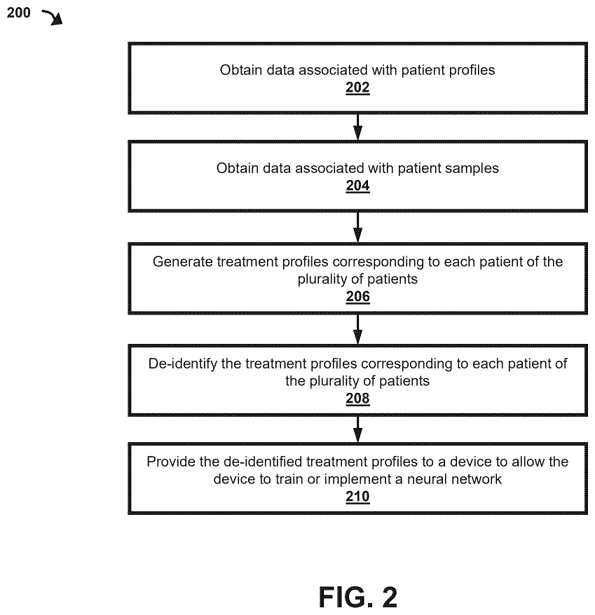

FIG. 2 is a flow diagram illustrating operations of a method 200 for managing patient data, in accordance with one or more embodiments described herein. In some implementations, one or more of the functions described with respect to the method 200 can be performed (e.g., completely, partially, and/or the like) by an analytics server (or one or more components thereof) that is the same as, or similar to, the analytics server 102 of FIG. 1. In some implementations, one or more of the functions described with respect to the method 200 can be performed (e.g., completely, partially, and/or the like) by another device or group of devices separate from and/or including the analytics server, such as by one or more client devices that are the same as, or similar to, the client device 126 of FIG. 1.

At operation 202, the analytics server can obtain patient data associated with patient profiles. For example, the analytics server can obtain the patient data that is associated with the patient profiles of one or more patients, where the one or more patients are or are not involved in treatment for one or more diseases. In this example, the patient profiles can include bibliographic data associated with bibliographic information about the one or more patients (e.g. name, date of birth, address, family history of the one or more diseases (or related diseases), and/or the like). In some examples, the bibliographic information can represent a medical history of the patient (e.g., diagnosis of the one or more diseases, date(s) of diagnosis, treatment(s), date(s) of treatment, and/or the like). In some embodiments, the analytics server can obtain the patient data from a client device that is controlled by a clinician. For example, the client device can receive input from a clinician indicative of the bibliographic information about the patient, generate the patient data, and provide the patient data to the analytics server. In these examples, the analytics server can store the patient data in a global patient database (e.g., that is the same as, or similar to, the global patient database 110 of FIG. 1) based on receiving the patient data.

At operation 204, the analytics server can obtain sample data associated with the patient profiles. In some embodiments, the analytics server can obtain the sample data associated with the patients represented by the patient profiles described herein from a laboratory system (e.g., that is the same as, or similar to, the laboratory system 112 of FIG. 1). For example, the analytics server can obtain the sample data from the laboratory system, where the sample data is associated with (e.g., represents) one or more biomarkers (also referred to as indicators) for the one or more diseases. In an example, the sample data can be associated with (e.g., represent test results indicating) protein expression of one or more genes (e.g., proteins encoded by genes such as, for example, the CD70 gene) and/or one or more DNA mutations. In this example, where the protein expression satisfies an expression level, the mutations are or are not present, etc., the sample data can indicate whether the patient has or does not have the one or more diseases (e.g., AML and/or the like). It will be understood that the sample data can be associated with any suitable biomarker other than those explicitly described herein.

In some embodiments, the sample data can be generated based on the output of a laboratory system. For example, the analytics server can receive sample data from the laboratory system based on analysis of the one or more samples by the laboratory system. In this example, the laboratory system can receive the patient samples (e.g. blood samples, tissue samples obtained through biopsies, and/or the like) and process the patient samples. The laboratory system can then generate the sample data based on the laboratory system processing the patient samples (e.g., based on flow cytometry, polymerase chain reaction, and/or the like). In some embodiments, the laboratory system can then provide (e.g., transmit) the sample data to the analytics server to cause the analytics server to store the sample data in the global patient database and/or the sequence database as described herein.

In some embodiments, the analytics server can receive the sample data at different points in time in comparison to the patient data. For example, the analytics server can receive the sample data at a first point in time (e.g., based on an initial collection of the patient samples when initially diagnosing the patient). In this example, the analytics server can receive additional sample data at one or more later points in time. For example, as a patient undergoes treatment and patient samples are collected to measure the progression of the diseases for which the patient is treated, the analytics server can iteratively receive sample data when the sample data is generated. The analytics server can then generate and/or update one or more treatment profiles and/or limited treatment profiles based on the sample data received from the laboratory system as described herein.

In some embodiments, the analytics server can receive sequence data based on further processing of the sample data and/or the samples collected from the patient(s). For example, where the laboratory system generates the sample data, the laboratory system can transmit the sample data and/or the processed samples to a sequencing system (e.g., that is the same as, or similar to, the sequencing system 118 of FIG. 1). The sequencing system can process the sample data and/or the samples obtained from the laboratory system to identify sequence information associated with DNA sequences represented by the samples (also referred to as “sequenced DNA”). Once processed, the sequencing system can generate sequence data associated with the sequenced DNA and transmit the sequence data to the analytics server. The analytics server can store the sequence data in a sequence database to later be included in a treatment profile and/or limited treatment profile as described herein.

At operation 206, the analytics server can generate one or more treatment profiles for one or more patients. For example, the analytics server can generate the one or more treatment profiles based on receiving the patient data and/or sample data of the one or more patients. The one or more treatment profiles can each correspond to a respective patient that is or is not being treated for the one or more diseases described herein. In some embodiments, the analytics server can generate the one or more treatment profiles, where each treatment profile includes one or more entries that are based on (e.g., represent) the patient data and/or sample data. For example, the analytics server can generate the one or more treatment profiles such that each treatment profile includes one or more entries based on the patient data and/or sample data and representative of a state of the health of each patient. The state of the health of the patient can be represented by one or more biomarkers identified and/or measured over time as described herein. Once generated, the analytics server can store the treatment profiles in the global patient database. For example, the analytics server can store the treatment profiles alone or in association with the corresponding patient data and/or sequence data represented by the one or more entries of the treatment profile. In this example, the analytics server can store the treatment profiles with the corresponding patient data and/or sample data based on the analytics server determining that the patient corresponding to a given treatment profile is associated with (e.g., corresponds to) the respective portion(s) of the patient data and/or sample data.

In some embodiments, the analytics server can generate each treatment profile such that each treatment profile includes a profile identifier. For example, the analytics server can generate each treatment profile to include a profile identifier that is based on one or more aspects of the data represented by the treatment profile. In examples, the profile identifier can be included as an entry in the treatment profile that identifies the corresponding patient (e.g., name, date of birth, government identifier, and/or the like). Additionally, or alternatively, the profile identifier can be associated with a number that is randomly generated by the analytics server when initially generating the treatment profile for the patient. The profile identifier can also be associated with a number that is generated based on one or more deterministic algorithms. For example, the analytics server can determine the profile identifier based on the analytics server applying a cryptographic hash function to at least a portion of the treatment profile of the patient. In this example, the analytics server can determine the profile identifier based on the analytics server applying a cryptographic hash function to one or more of the entries in the treatment profile to determine the profile identifier.

In some embodiments, the entries in the treatment profile can be indexed using time stamps. For example, the analytics server can include one or more entries in a given treatment profile based on the corresponding patient data and/or sample data for the patient represented by the treatment profile. In this example, the entries can be associated with time stamps that indicate the point at which the patient data and/or sample data was generated. Additionally, or alternatively, the time stamps can indicate when the patient data and/or sample data was received by the analytics server. For example, the time stamps corresponding to respective entries of the treatment profiles can be entered and/or edited by a clinician through a client device and the analytics server can include the time stamps in the entries of the treatment profile being entered or edited. Additionally or alternatively, time stamps can indicate a real-world element of an entry (e.g. when an action was performed, a sample was analyzed, and/or the like). For example, an entry can have one or more time stamps that indicate a start date and/or an end date of a particular treatment. In another example, an entry can have one or more time stamps that indicate points in time at which one or more samples for a given patient were collected and analyzed (e.g., by a laboratory system as described herein).

At operation 208, the analytics server can de-identify the treatment profiles corresponding to each patient of the plurality of patients. For example, the analytics server can de-identify the treatment profiles to generate limited treatment profiles for each patient of the plurality of patients. In some embodiments, the analytics server can generate each limited treatment profile such that each limited treatment profile includes an entry for a pseudo-identifier that corresponds to the patient identifier of the corresponding treatment profile. The analytics server can generate each limited treatment profile to include the pseudo-identifier as replacement for the profile identifier, where the pseudo-identifier includes a combination of characters (e.g., numbers, letters, symbols, and/or the like) from which the patient associated with the limited treatment profile cannot be identified. In some examples, the analytics server can generate the pseudo-identifiers of the limited treatment profiles based on one or more aspects of the corresponding treatment profiles. In other examples, the analytics server can generate pseudo-identifiers of the limited treatment profiles independent of the one or more aspects of the corresponding treatment profiles (e.g., at random and/or the like).

In some embodiments, the analytics server can determine one or more aspects of the treatment profile to use when generating the pseudo-identifier. For example, the analytics server can determine the one or more aspects of the treatment profile that were previously used to generate the profile identifier when generating the pseudo-identifier. In some embodiments, the analytics server can then generate the pseudo-identifier by executing one or more operations to the one or more aspects of the treatment profile. Examples of the one or more operations can include a function that is difficult or infeasible to reverse, such as a cryptographic hash.

In some embodiments, the analytics server can map the pseudo-identifier of a limited treatment profile to a profile identifier of a corresponding treatment profile. For example, the analytics server can map the pseudo-identifier for a limited treatment profile of a patient to the profile identifier of the patient when generating the pseudo-identifier as described herein. The analytics server can then store the mapping of the pseudo-identifier to the profile identifier in a data index. In some embodiments, the analytics server can store the de-identified data index in the data integration engine. Additionally, or alternatively, the analytics server can cause the data integration engine to generate and maintain the pseudo-identifiers when generating the limited treatment profiles as described herein. In some embodiments, the analytics server can cause the data integration engine to update the limited treatment profiles based on the mapping of the pseudo-identifier to the profile identifier and one or more changes to the treatment profile that corresponds to the limited treatment profile as described herein.

In some embodiments, the analytics server can de-identify the treatment profile by offsetting time stamps associated with one or more entries in the treatment profile when generating the corresponding limited treatment profile. In an example, the analytics server can determine a first period of time associated with a treatment profile, where the first period of time starts at the point in time indicated by the first time stamp of the first entry in the treatment profile. The analytics server can then determine a period offset for the treatment profile. The period offset can include a period of time according to which time stamps of each entry of a treatment profile should be updated (e.g., added to or subtracted from) when generating a limited treatment profile. In examples, the period offset can be generated such that the period offset is different (e.g., unique) when compared to period offsets of one or more other treatment profiles. In some embodiments, the analytics server can determine the period offset such that the period offset maintains one or more aspects of the treatment profile. For example, the analytics server can determine the period offset such that the entries in the treatment profile maintain their relative position in time when compared to the other entries (e.g., a treatment that starts one month after the treatment profile is created is offset in accordance with the period offset, but still starts one month after the first entry of the limited treatment profile) when represented in the limited treatment profile. In some embodiments, the analytics server can then store the period offset that is associated with the treatment profile in the de-identified data index (e.g., in association with the corresponding pseudo-identifier). In this way, the analytics server can allow for future updates to the limited treatment profile using the period offset without having to re-generate the entire limited treatment profile, as described herein.

In some embodiments, the analytics server can create entries with time stamps in the limited treatment profile based on shifting the time stamps of entries in the associated treatment profile in accordance with the period offset of the treatment profile. For example, the analytics server can create a de-identified entry with a shifted time stamp in a limited treatment profile based on shifting the time stamp in the corresponding entry in the treatment profile by the period offset. The analytics server can then add the de-identified entry to the limited treatment profile. In some examples, the analytics server can iteratively generate de-identified entries with shifted time stamps in the limited treatment profile based on the corresponding entries of the treatment profile. In this way, the analytics server can consistently shift the time stamps of the entries in the treatment profile when generating the entries of the corresponding limited treatment profile.

In some embodiments, where the treatment profile and/or limited treatment profile are already initialized based on the techniques described herein, the analytics server can receive patient data and/or sample data associated with an existing treatment profile (e.g., at one or more points in time after the treatment profile is generated). For example, patient data and/or sample data can be generated based on subsequent analysis of one or more patient samples. In this example, the laboratory system and/or the sequencing system can include the profile identifier corresponding to the patient sample when generating the patient data and/or sample data. In some embodiments, the analytics server can obtain the patient data and/or the sample data and update the treatment profile associated with the profile identifier to include one or more new entries that are based on the patient and/or sample data. For example, the analytics server can determine that the profile identifier matches the profile identifier of the treatment profile stored in the global patient database and update the treatment profile to include entries based on the patient data and/or the sample data. In another example, the analytics server can determine the profile identifier based on the patient data and/or the sample data. The analytics server can then add and/or update one or more entries in the treatment profile for the patient associated with the patient identifier.

In some embodiments, the analytics server can determine that a treatment profile transitioned from a first state to a second state. For example, the analytics server can determine that a treatment profile was updated as described herein and, as a result, transitioned from a first state (e.g., an un-updated state) to a second state (an updated state). In some embodiments, the analytics server can de-identify the new entries as described herein based on determining that the treatment profile transitioned from the first state to the second state. For example, the analytics server can shift the time stamps of the entries based on the period offset associated with the treatment profile. The analytics server can then identify a limited treatment profile associated with the existing treatment profile. For example, the analytics server can identify the associated limited treatment profile based on identifying the pseudo-identifier that correspond to the profile identifier of the existing treatment profile. In this example, the analytics server can update the limited treatment profile with the de-identified entries. The analytics server can then store the limited treatment profile in the refined datasets (e.g., that are the same as, or similar to, the refined datasets 108 of FIG. 1).

At operation 210, the analytics server can provide the de-identified treatment profiles (e.g., the limited treatment profiles) to a device to allow the device to train and/or implement a neural network. For example, the analytics server can provide the de-identified treatment profiles to a data discovery engine (e.g., that is the same as, or similar to, the data discovery engine 106 of FIG. 1). In this example, the data discovery engine can obtain the limited treatment profiles containing entry data associated with the one or more entries included in each respective limited treatment profile. The data discovery engine can then provide the entry data associated with the limited treatment profiles to one or more models of a model development environment implemented by the data discovery engine (e.g., a model development environment that is the same as, or similar to, the model development environment 106a of FIG. 1).

In some embodiments, the model development environment can execute one or more machine learning models based on the entry data associated with the limited treatment profiles. For example, the model development environment can provide the entry data associated with the limited treatment profiles to the one or more machine learning models to cause the respective machine learning models to generate outputs during training and/or implementation of the one or more machine learning models. The outputs can include, for example, predictions of whether the patient associated with the limited treatment profile has a disease. Additionally, or alternatively, the outputs can include data associated with one or more treatments to be provided to a patient, data indicating that one or more biomarkers are correlated with a given disease (e.g., generally or at a given stage of progression for the disease), and/or the like. In other examples the outputs can include a recommendation of which treatment(s) would be effective to reduce, stop, and/or reverse progression of the disease of the patient associated with the limited treatment profile.

In some embodiments, the output of the models executed by the data discovery engine can be generated and stored by the data discovery engine in a discovery engine database (e.g., that is the same as, or similar to, the discovery engine database 106b of FIG. 1). For example, the output of the models executed by the data discovery engine can be generated and stored in a discovery engine database in association with the pseudo-identifier from the corresponding limited treatment profile provided as input to the data discovery engine. In some embodiments, the output of the models and the pseudo-identifier can then be provided to the data integration engine. For example, the data discovery engine can provide to the data integration engine the output of the models and the pseudo-identifier stored in the discovery engine database. In this example, the data integration engine can identify the treatment profile (e.g., stored in the global patient database) and/or limited treatment profile (e.g., stored in the refined datasets) the output of the models corresponds to based on the pseudo-identifier. The data integration engine can then store the output of the models as an update in the appropriate profile. For example, the data integration engine can determine the profile identifier that corresponds to the pseudo-identifier and store the output of the model in the corresponding treatment profile in the global patient database. In another example, the data integration engine can access the refined datasets and store the update in the appropriate limited treatment profile based on the pseudo-identifier associated with the output of the models.

In some examples, the output of the models can include a time stamp. In these examples, the analytics server can determine a period offset corresponding to the pseudo-identifier and/or profile identifier associated with the output of the models in the de-identified data index to use when generating and/or updating entries in the treatment profiles and/or limited treatment profiles. For example, the analytics server can generate and/or update the time stamp included with the output of the models according to the period offset such that the time stamps indicate the true (e.g., non-offset) points in time for each entry. For example, if the time stamps in a limited treatment profile are generated by adding the period offset to the time stamps in a respective treatment profile, the analytics server can modify the time stamp included with the output of the models by subtracting the period offset from the time stamp. In examples, the data integration engine can then store the output of the models with the time stamps in the appropriate treatment profile. In this way, the analytics server can update the treatment profiles and/or limited treatment profiles based on the output of the models by adding entries representing the output of the models to the treatment profiles and/or limited treatment profiles, respectively, that have appropriate time stamps.

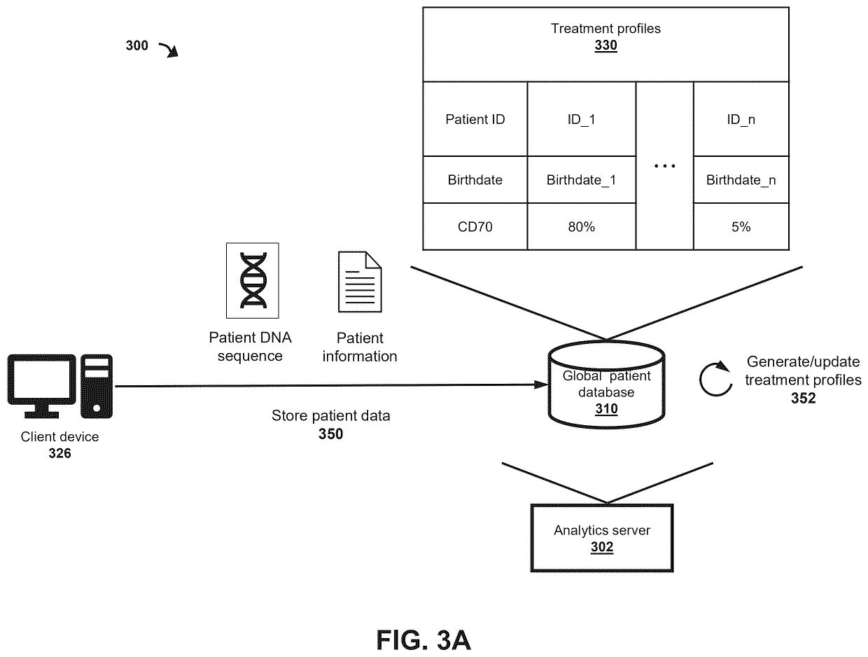

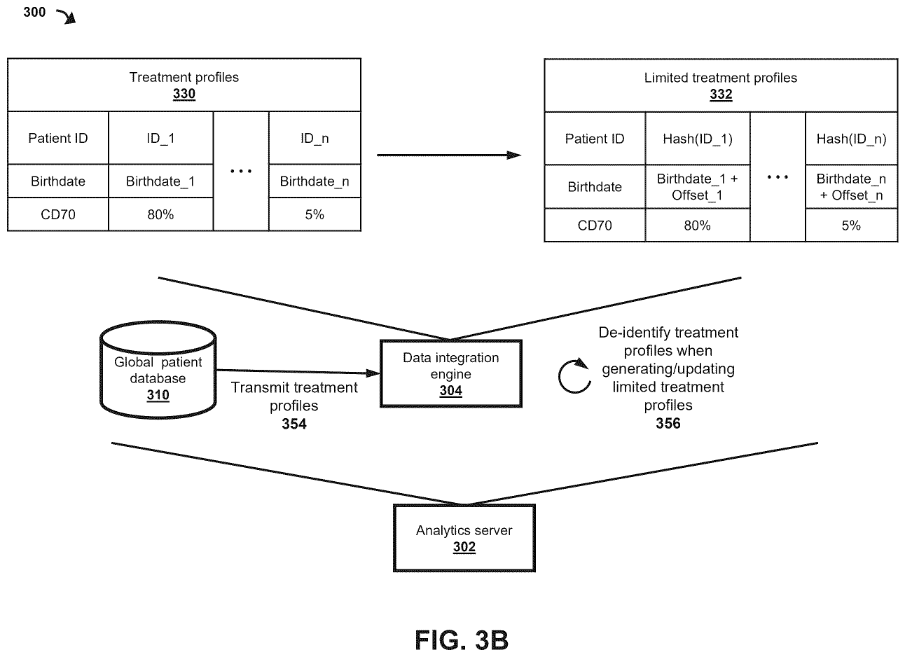

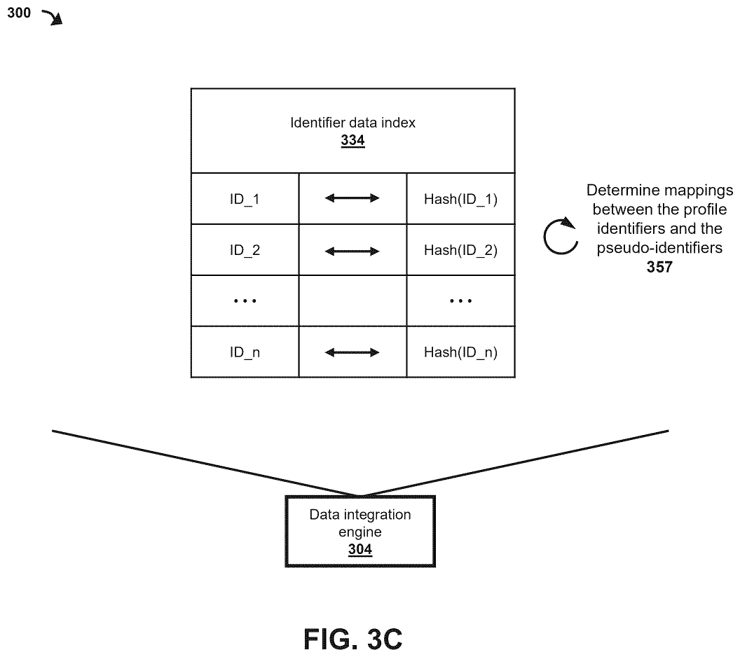

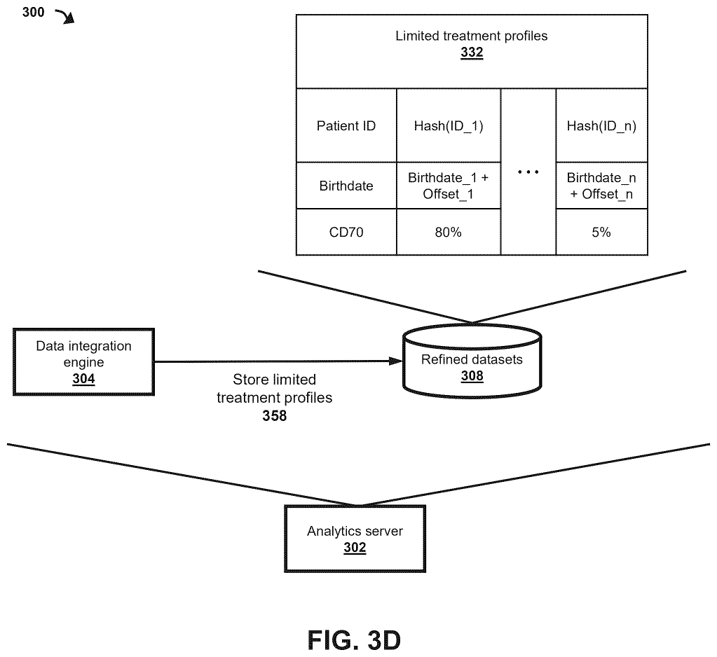

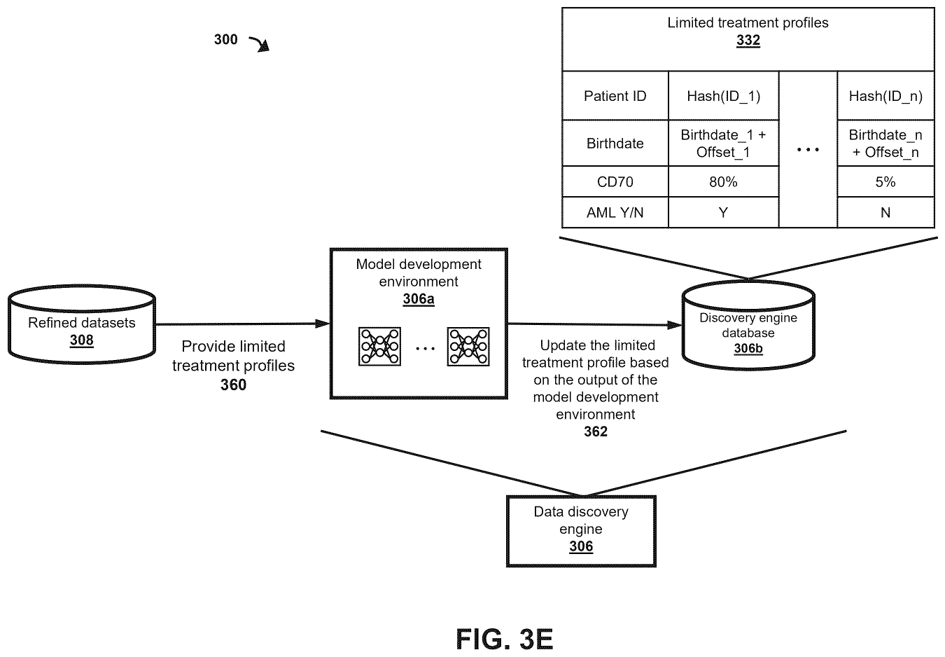

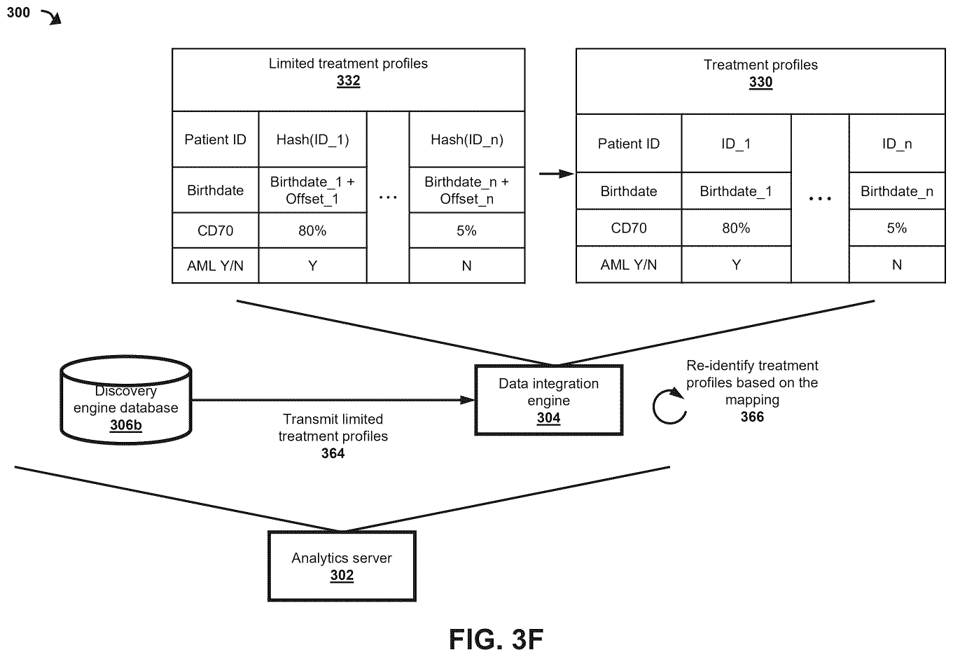

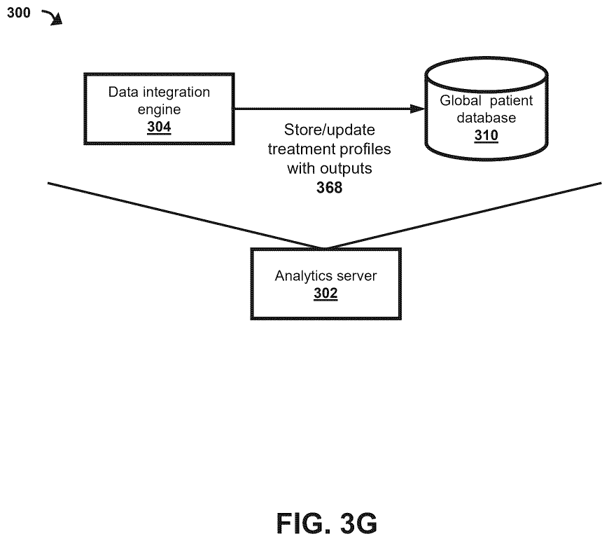

FIG. 3A-3H are a diagram of an example implementation 300 of the method 200 of FIG. 2, in accordance with one or more embodiments described herein. In some embodiments, the operations of the implementation 300 can be implemented by an analytics server 302, a global patient database 310, a laboratory system 314, and a sequencing system 318 that are the same as, or similar to, the analytics server 102, the global patient database 110, the laboratory system 114, and the sequencing system 118 of FIG. 1. Additionally, or alternatively, one or more of the operations of the implementation 300 can involve a data integration engine 304, a global patient database 310 and/or a sequence database 319 that are the same as, or similar to, the data integration engine 104, a global patient database 110 and/or a sequence database 119 of FIG. 1.

At operation 350, patient data can be provided (e.g. transmitted) by a client device 326 to the analytics server 302. In an embodiment, a clinician can provide patient data to the client device 326 indicating observations of the patient, a diagnosis, biographical information, lab sample data, and/or configure a treatment plan for the patient. This patient data can be provided at a first visit between the patient and the clinician and/or at one or more subsequent visits between the patient and the clinician. Based on the receipt of the patient data, the client device 326 can provide the patient data to the analytics server 302 to be stored in a global patient database 310 of the analytics server.

At operation 352, treatment profiles (e.g., for patient ID_1, ID_2, ID_n) can be generated and/or updated based on the patient data received by the analytics server 302. In an embodiment, the analytics server can cause the patient data to be stored in the global patient database 310. The analytics server 302 can then cause the treatment profile to be generated and/or updated based on the patient data. For example, the analytics server 302 can generate a treatment profile for the patient including a patient identifier and/or one or more portions of the patient data as entries in the treatment profile. The analytics server 302 can also associate the entries with time stamps indicating times at which the data included in each entry was generated and/or received. In some embodiments, the time stamps can indicate a time that the analytics server received the patient data. In other embodiments, the time stamps can indicate a time that the client device received input and/or generated the patient data. In another embodiment, the time stamp can be a time entered along with the patient data. In yet another embodiment, the patient data received by the analytics server 302 can be associated with a patient identifier. The analytics server 302 can add the patient data as an update to an existing treatment profile based on matching the patient identifier associated with the patient data to the patient identifier of the existing treatment profile.

At operation 354, the analytics server 302 can cause data associated with the treatment profiles 330 to be provided (e.g., transmitted) to the data integration engine 304. For example, in response to treatment profiles 330 being created and/or updated, the analytics server 302 can cause data associated with the treatment profiles 330 to be provided to the data integration engine 304.

At operation 356, the analytics server 302 can cause the data integration engine 304 to generate and/or update limited treatment profiles 332 for each of the treatment profiles 330. For example, the analytics server 302 can cause the data integration engine 304 to generate a limited treatment profile for each treatment profile, such that the limited treatment profiles 332 include a pseudo-identifier in place of a patient identifier (illustrated as Hash(ID_1)-Hash(ID_n)). Additionally, or alternatively, the analytics server 302 can cause the data integration engine 304 to generate limited treatment profiles 332 corresponding to the treatment profiles 330, where the entries included in a limited treatment profile are associated with second time stamps that are offset from the first time stamps included with each entry in a treatment profile. In this way, the analytics server 302 can curate a refined dataset 308 that includes limited treatment profiles 332 that, in part, include patient data that can be used in research settings without the need for further abstraction (e.g., to comply with one or more laws, regulations, and/or the like) to reduce the chances of re-identification of the patient.

At operation 357, the analytics server 302 can determine a mapping between the profile identifier and the corresponding pseudo-identifier based on generating the pseudo-identifier. In some examples, the analytics server 302 can store the mapping in a de-identified data index 334. For example, the analytics server 302 can cause the de-identified data index to be stored in the data integration engine 304 to later be used when updating data included in the treatment profiles and/or the limited treatment profiles as described herein.

At operation 358, the analytics server 302 can cause the data integration engine 304 to store the limited treatment profiles 332 in the refined datasets database 308. For example, the analytics server 302 can cause the data integration engine 304 to store the limited treatment profiles 332 in the refined datasets database 308, such that the limited treatment profiles 332 are made available to other systems or processing engines implemented by the analytics server 302 or to systems or processing engines implemented by remote devices (e.g., client devices operated by other research organizations and/or the like).

At operation 360, the analytics server 302 can cause the refined datasets 308 to provide the limited treatment profiles 332 to a data discovery engine 306. Based on the limited treatment profiles 332, the data discovery engine 306 can perform one or more operations. In some embodiments, the data discovery engine can implement a model development environment 306a. The model development environment 306a can include one or more machine learning models (e.g. one or more neural networks, linear regression models, decision tree models, and/or the like). Based on the limited treatment profiles 332, the model development environment 306a can perform one or more operations. In some embodiments, these operations can include training the machine learning model. Alternatively, these operations can include implementing the machine learning model to create one or more model outputs based on the limited treatment profiles 332. For example, model outputs can include a prediction of whether a patient has a disease and/or a recommendation for a treatment plan to treat their disease.

At operation 362, the analytics server 302 can cause data discovery engine 306 to store updates in the limited treatment profiles 332 with the model outputs. In some embodiments, the data discovery engine 306 can include a discovery engine database 306b. In an example, the analytics server 302 can cause the data discovery engine 306 to store the model outputs with one or more entries of the limited treatment profiles in the discovery engine 306b based on receiving the model outputs as a result of execution of one or more models in accordance with the limited treatment profiles from the model development environment 306a. In an embodiment, the one or more entries of a limited treatment profile can amount to the entire limited treatment profile.

At operation 364, the analytics server 302 can cause the data discovery engine 306 to provide (e.g. transmit) the limited treatment profiles 332 and/or the updates to the limited treatment profiles 332 to the data integration engine 304. In some embodiments, the analytics server 302 can cause the discovery engine database 306b to provide the limited treatment profiles 332 to the data integration engine. In another embodiment, the data discovery engine 302 can provide the limited treatment profiles 332 to the data integration engine 304.

At operations 366, the analytics server 302 can cause the data integration engine 304 to re-identify limited treatment profiles 332 by determining corresponding treatment profiles 330. In some embodiments, the analytics server 302 can determine a patient identifier corresponding to a pseudo-identifier. For example, the analytics server 302 can determine treatment profiles 330 corresponding to limited treatment profiles 332 based on accessing the de-identified data index 334 that contains the mapping between profile identifiers and pseudo-identifiers. The analytics server 302 can then re-identify the treatment profile based on the mapping between the profile identifiers and the pseudo-identifiers.

At operations 368, the analytics server 302 can store the updates in the treatment profiles 330 or the limited treatment profiles 332 based on the re-identification of the treatment profile. In an embodiment, the analytics server 302 can cause the data integration engine 302 to access the global patient database 310. The analytics server can then store the updates in the treatment profiles 330 in the global patient database 310 based on the identification of the corresponding limited treatment profiles 332. In another embodiment, the analytics server 302 can cause the data integration engine 302 to access the refined datasets 308. The analytics server can store the updates within the limited treatment profiles 332 contained in the refined datasets 308. In an embodiment, a client device 326 can cause the analytics server 302 to access the treatment profiles 330 with the updates.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of this disclosure or the claims.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc., can be passed, forwarded, or transmitted via any suitable means, including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate the transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein can be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system for protecting profiles in a protected dataset maintained in a secured network location, comprising:
one or more processors configured to:
obtain individual data for an individual, the individual data associated with an individual profile and generated at a first point in time;
obtain sample data associated with one or more indicators for a condition, the sample data generated based on an output of a processing system at a second point in time when processing a sample obtained from the individual;
generate a treatment profile based on the individual data and the sample data, the treatment profile comprising a plurality of entries indexed in accordance with a period of time, the plurality of entries representing the individual profile and the one or more indicators for the condition,
de-identify the treatment profile of the individual to generate a limited treatment profile; and
provide the limited profile data associated with the limited treatment profile to a device to allow the device to execute one or more operations involved in training or implementing a neural network.

2. The system of claim 1, wherein the one or more processors configured to generate the treatment profile are configured to:
generate a profile identifier based on one or more aspects of the profile of the individual; and
wherein the one or more processors configured to de-identify the treatment profile of the individual are configured to:
generate a pseudo-identifier;
map the pseudo-identifier to the profile identifier in a de-identified data index; and
generate the limited treatment profile based on the pseudo-identifier, wherein the pseudo-identifier is used as a replacement for the profile identifier.

3. The system of claim 2, wherein the one or more processors configured to generate the pseudo-identifier are configured to:
determine one or more aspects of the treatment profile to be used when generating the pseudo-identifier; and
applying a cryptographic hash function the one or more aspects of the treatment profile to generate the pseudo-identifier.

4. The system of claim 1, wherein the one or more processors configured to de-identify the treatment profile of the individual are configured to:
determine a first period of time associated with the treatment profile of the individual, the first period of time starting at the first point in time corresponding to a first entry in the treatment profile; and
determine a period offset that maintains one or more aspects of the treatment profile, and
wherein the one or more processors configured to generate the limited treatment profile are configured to:
determine an updated set of entries based on the plurality of entries of the treatment profile and the period offset such that time stamps of the plurality of entries of the treatment profile are shifted in accordance with the period offset.

5. The system of claim 1, wherein the one or more processors are further configured to:
determine a transition of the treatment profile from a first state to a second state, the transition indicating an update to the plurality of entries of the treatment profile; and
update the limited treatment profile based on the update to the plurality of entries of the treatment profile.

6. The system of claim 5, wherein the one or more processors are further configured to:
identify a subset of entries of the plurality of entries that are added to the treatment profile; and
wherein the one or more processors configured to update the limited treatment profile are configured to:
de-identify a portion of the treatment profile corresponding to the subset of entries; and
update the limited treatment profile based on the portion of the treatment profile that was de-identified.

7. The system of claim 6, wherein the one or more processors configured to provide the limited profile data associated with the limited treatment profile to the device are further configured to:
provide the limited treatment profile to a model development environment executed by the device to cause the model development environment to generate an update to the plurality of entries of the limited treatment profile,
wherein the model development environment comprises a plurality of neural networks that are configured to receive the limited treatment profile as an input and generate the update to the plurality of entries of the limited treatment profile as an output;
determine one or more updates to the plurality of entries of the treatment profile based on the update to the plurality of entries of the limited treatment profile; and
update the treatment profile based on the one or more updates to the plurality of entries.

8. The system of claim 7, wherein the plurality of entries of the limited treatment profile are associated with a pseudo-identifier of the individual, and
wherein the one or more processors configured to determine the one or more updates to the plurality of entries of the treatment profile are configured to:
determine the profile identifier for the individual based on the pseudo-identifier associated with the plurality of entries of the limited treatment profile;
determine a period offset mapped to the profile identifier for the individual; and
determine a set of entries to include in the treatment profile based on the plurality of entries of the limited treatment profile, each entry comprising a time stamp that is not shifted in accordance with a period offset associated with the limited treatment profile.

9. A method for protecting profiles in a protected dataset maintained in a secured network location, comprising:
obtaining individual data for an individual, the individual data associated with an individual profile and generated at a first point in time;
obtaining sample data associated with one or more indicators for a condition, the sample data generated based on an output of a processing system at a second point in time when processing a sample obtained from the individual;
generating a treatment profile based on the individual data and the sample data, the treatment profile comprising a plurality of entries indexed in accordance with a period of time, the plurality of entries representing the individual profile and the one or more indicators for the condition;
de-identifying the treatment profile of the individual to generate a limited treatment profile; and
providing the limited profile data associated with the limited treatment profile to a device to allow the device to execute one or more operations involved in training or implementing a neural network.

10. The method of claim 9, further comprising:
generating a profile identifier based on one or more aspects of the profile of the individual; and
wherein de-identifying the treatment profile of the individual further comprises:
generating a pseudo-identifier;
mapping the pseudo-identifier to the profile identifier in a de-identified data index; and
generating the limited treatment profile based on the pseudo-identifier, wherein the pseudo-identifier is used as a replacement for the profile identifier.

11. The method of claim 10, wherein generating the pseudo-identifier further comprises:
determining one or more aspects of the treatment profile to be used when generating the pseudo-identifier; and
applying a cryptographic hash function the one or more aspects of the treatment profile to generate the pseudo-identifier.

12. The method of claim 9, wherein de-identifying the treatment profile of the individual further comprises:
determining a first period of time associated with the treatment profile of the individual, the first period of time starting at the first point in time corresponding to a first entry in the treatment profile; and
determining a period offset that maintains one or more aspects of the treatment profile, and
wherein generating the limited treatment profile further comprises:
determining an updated set of entries based on the plurality of entries of the treatment profile and the period offset such that time stamps of the plurality of entries of the treatment profile are shifted in accordance with the period offset.

13. The method of claim 9, wherein the method further comprises:
determining a transition of the treatment profile from a first state to a second state, the transition indicating an update to the plurality of entries of the treatment profile; and
updating the limited treatment profile based on the update to the plurality of entries of the treatment profile.

14. The method of claim 13, wherein the method further comprises:
identifying a subset of entries of the plurality of entries that are added to the treatment profile; and
wherein updating the limited treatment profile further comprises:
de-identifying a portion of the treatment profile corresponding to the subset of entries; and
updating the limited treatment profile based on the portion of the treatment profile that was de-identified.

15. The method of claim 14, wherein providing the limited profile data associated with the limited treatment profile further comprises:
providing the limited treatment profile to a model development environment executed by the device to cause the model development environment to generate an update to the plurality of entries of the limited treatment profile,
wherein the model development environment comprises a plurality of neural networks that are configured to receive the limited treatment profile as an input and generate the update to the plurality of entries of the limited treatment profile as an output;
determining one or more updates to the plurality of entries of the treatment profile based on the update to the plurality of entries of the limited treatment profile; and
updating the treatment profile based on the one or more updates to the plurality of entries.

16. A non-transitory computer-readable medium storing instructions thereon that, when executed by at least one processor, cause the at least one processor to
obtain individual data for an individual, the individual data associated with an individual profile and generated at a first point in time;
obtain sample data associated with one or more indicators for a condition, the sample data generated based on an output of a processing system at a second point in time when processing a sample obtained from the individual;
generate a treatment profile based on the individual data and the sample data, the treatment profile comprising a plurality of entries indexed in accordance with a period of time, the plurality of entries representing the individual profile and the one or more indicators for the condition;
de-identify the treatment profile of the individual to generate a limited treatment profile; and
provide the limited profile data associated with the limited treatment profile to a device to allow the device to execute one or more operations involved in training or implementing a neural network.

17. The non-transitory computer-readable medium of claim 16, wherein the instructions further cause the at least one processor to:
determine a transition of the treatment profile from a first state to a second state, the transition indicating an update to the plurality of entries of the treatment profile; and
update the limited treatment profile based on the update to the plurality of entries of the treatment profile.

18. The non-transitory computer-readable medium of claim 17, wherein the instructions further cause the at least one processor to:
identify a subset of entries of the plurality of entries that are added to the treatment profile; and
wherein the one or more processors configured to update the limited treatment profile are configured to:
de-identify a portion of the treatment profile corresponding to the subset of entries; and
update the limited treatment profile based on the portion of the treatment profile that was de-identified.

19. The non-transitory computer-readable medium of claim 18, wherein the instructions cause the at least one processor configured to provide the limited profile data associated with the limited treatment profile to the device further cause the at least one processor to:
provide the limited treatment profile to a model development environment executed by the device to cause the model development environment to generate an update to the plurality of entries of the limited treatment profile,
wherein the model development environment comprises a plurality of neural networks that are configured to receive the limited treatment profile as an input and generate the update to the plurality of entries of the limited treatment profile as an output;
determine one or more updates to the plurality of entries of the treatment profile based on the update to the plurality of entries of the limited treatment profile; and
update the treatment profile based on the one or more updates to the plurality of entries.

20. The non-transitory computer-readable medium of claim 19, wherein the plurality of entries of the limited treatment profile are associated with a pseudo-identifier of the individual, and
wherein the instructions that cause the at least one processor to determine the one or more updates to the plurality of entries of the treatment profile cause the at least one processor to:
determine the profile identifier for the individual based on the pseudo-identifier associated with the plurality of entries of the limited treatment profile;
determine a period offset mapped to the profile identifier for the individual; and
determine a set of entries to include in the treatment profile based on the plurality of entries of the limited treatment profile, each entry comprising a time stamp that is not shifted in accordance with a period offset associated with the limited treatment profile.
